(19) United States
(12) Patent Application Publication
(10) Pub. No.: US 2018/0349837 A1
(43) Pub. Date: Dec. 6, 2018

(54) SYSTEM AND METHOD FOR INVENTORY MANAGEMENT WITHIN A WAREHOUSE

(71) Applicant: HCL TECHNOLOGIES LIMITED, UTTAR PRADESH (IN)

(72) Inventors: MUDHUSUDHAN RANJANGHATMURALIDHAR, TAMIL NADU (IN); ASHAR PASHA, DALLAS, TX (US)

(21) Appl. No.: 15/982,951

(22) Filed: May 17, 2018

(30) Foreign Application Priority Data
May 19, 2017 (IN) 201711017686

(51) Int. Cl. G06Q 10/08; G06K 9/00; G06T 19/00; G06F 17/30

(52) U.S. Cl. CPC G06Q 10/087; G06K 9/00744; G06F 17/30321; G06T 19/003; G06T 19/006; G06K 9/00671

(57) ABSTRACT

The present disclosure relates to system(s) and method(s) for inventory management using augmented reality within a warehouse. In one embodiment, the system receives a video stream from a wearable device associated with a user in a warehouse and identifies a product and one or more parameters associated with the product based on analysis of the video stream. In one example, the video stream may comprise one or more video frames corresponding, to the product. Upon identification, the system generates validation data based on validation of the product with a validation list and updating the inventory data with the validation data associated the product, thereby enabling inventory management using augmented reality within a warehouse.

### CROSS-REFERENCE TO RELATED APPLICATIONS AND PRIORITY

The present application claims priority from Indian Patent Application No. 201711017686 filed on 19 May, 2017 the entirety of which is hereby incorporated by reference

TECHNICAL FIELD

The present disclosure in general relates to the field of inventory management. More particularly, the present invention relates to a system and method for inventory management based on augmented reality within a warehouse.

### BACKGROUND

Nowadays, with the growth in industry and e-commerce a large number of warehouses with stock are set up to meet the market and manufacturing requirement. Inventory management of the stock in the warehouse is one of the critical tasks of a supply chain, as improper or wrong stock management would lead to profit loss, damage to brand image, and even legal suite. Inventory management may be understood as the supervision of inventory and stock items. A component of supply chain management, inventory management supervises the flow of goods from manufacturers to warehouses and from these facilities to point of sale.

Currently, conventional system and method for inventory management in a warehouse is mostly manual labour intensive paper based process, leading to manual errors, stock variance, stock mismatch, reduced resource productivity and high cost. Further, due to utilization of the conventional system and process and unviability of real-time information, decision issues relating to inventory control such as the amount of stock in the warehouse, quantity of new stock, expired stock, forecasting for ordering new stock are encountered.

### SUMMARY

Before the present a system and a method for inventory management based on augmented reality within a warehouse, are described, it is to be understood that this application is not limited to the particular system, systems, and methodologies described, as there can be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to a system and a method for inventory management based on augmented reality within a warehouse. This summary is not intended to identify essential features of the claimed subject matter nor is it intended for use in determining or limiting the scope of the claimed subject matter.

In one embodiment, a method for inventory management based on augmented reality within a warehouse is disclosed. In the embodiment, the method may comprise receiving a video stream from a wearable device associated with a user in a warehouse and identifying a product and one or more parameters associated with the product based on analysis of the video stream. In one example, the video stream corresponds to gaze direction associated with the user and comprises one or more video frames corresponding to the product. Further to identifying, the method may comprise generating validation data based on validation of the product with a validation list. In one example, the validation data comprises a date, a time and a result of the validation, and the validation list comprises inventory data associated with a set of products to be validated. Upon validation, the method may comprise updating the inventory data with the validation data associated the product, thereby enabling inventory management using augmented reality within a warehouse.

In another embodiment, a system for inventory management based on augmented reality within a warehouse is disclosed. The system comprises a memory and a processor coupled to the memory, further the processor may be configured to execute programmed instructions stored in the memory. In one embodiment, the system may receive a video stream from a wearable device associated with a user in a warehouse and identify a product and one or more parameters associated with the product based on analysis of the video stream. In one example, the video stream corresponds to gaze direction associated with the user and comprises one or more video frames corresponding to the product. Upon identifying, the system may generate validation data based on validation of the product with a validation list. In example, the validation data may comprise a date, a time and a result of the validation, and the validation list may comprise inventory data associated with a set of products to be validated. Subsequent to validation the system may update the inventory data with the validation data associated the product, thereby enabling inventory management using augmented reality within a warehouse.

In yet another embodiment, a computer program product having embodied computer program for inventory management based on augmented reality within a warehouse, is disclosed. The program may comprise a program code for receiving a video stream from a wearable device associated with a user in a warehouse and identifying a product and one or more parameters associated with the product based on analysis of the video stream. In one example, the video stream corresponds to gaze direction associated with the user and may comprises one or more video frames corresponding to the product. The program may further comprise a program code for generating, by the processor, validation data based on validation of the product with a validation list. In one example, the validation data may comprise a date, a time and a result of the validation, and the validation list may comprise inventory data associated with a set of products to be validated. The program may furthermore comprise a program code for updating the inventory data with the validation data associated the product, thereby enabling inventory management using augmented reality Within a warehouse.

### BRIEF DESCRIPTION OF DRAWINGS

The foregoing detailed description of embodiments is better understood when read in conjunction with the appended drawings. For the purpose of illustrating of the present subject matter, an example of construction of the present subject matter is provided as figures; however, the invention is not limited to the specific method and system disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a system for inventory management based on augmented reality within a warehouse, in accordance with an embodiment of the present subject matter.

FIG. 2 illustrates the system for inventory management based on augmented reality within a warehouse, in accordance with an embodiment of the present subject matter.

FIG. 3 illustrates a method for inventory management based on augmented reality within a warehouse, in accordance with an embodiment of the present subject matter.

### DETAILED DESCRIPTION

Some embodiments of this disclosure, illustrating all its features, will now be discussed In detail. The words “receiving”, “identifying”, “generating”, “updating”, “guiding” “comprising,” “having,” “containing,” and “including,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any a system and a method for inventory management based on augmented reality within a warehouse, similar or equivalent to those described herein can be used in the practice or testing of embodiments of the present disclosure, the exemplary, a system and a method for inventory management based on augmented reality within a warehouse are now described. The disclosed embodiments for enabling a user to remotely perform an action in a real world via a virtual reality environment are merely examples of the disclosure, which may be embodied in various forms.

Various modifications to the embodiment will be readily apparent to those skilled in the art and the generic principles herein may be applied to other embodiments for inventory management based on augmented reality within a warehouse. However, one of ordinary skill in the art will readily recognize that the present disclosure for inventory management based on augmented reality within a warehouse is not intended to be limited to the embodiments described, but is to be accorded the widest scope consistent with the principles and features described herein.

The present subject matter relates to a system and method for inventory management based on augmented reality within a warehouse. In one embodiment of the present subject matter, a video stream from a wearable device associated with a user in a warehouse is received, and a product and one or more parameters associated with the product is identified based on analysis of the video stream. In one example, the video stream may correspond to gaze direction associated with the user and may comprises one or more video frames corresponding to the product, upon identification, validation data may be generated based on validation of the product with a validation list. In other example, the validation data may comprise a date, a time and a result of the validation, and the validation list may comprise inventory data associated with a set of products to be validated. Subsequent to generation, the inventory data update with the validation data associated the product, thereby enabling inventory management using augmented reality within a warehouse.

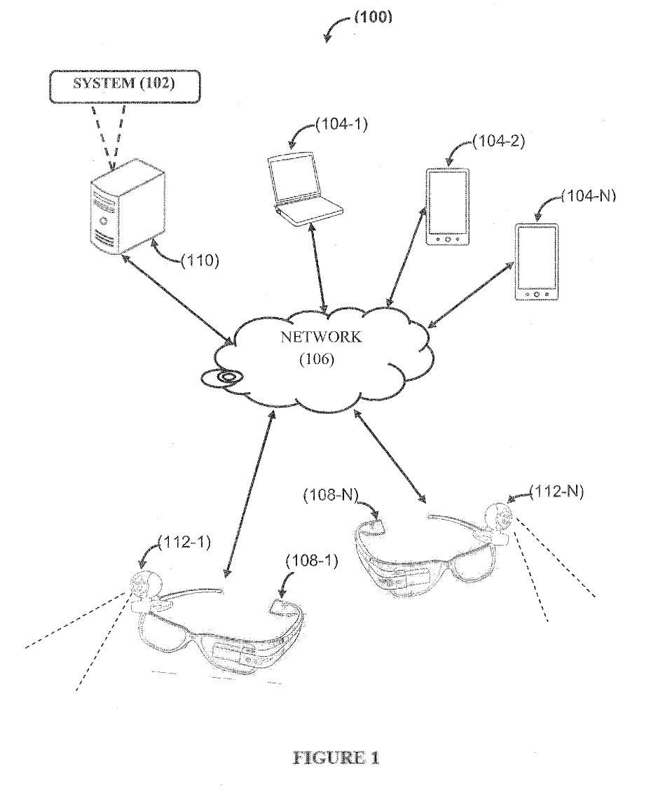

Referring now to FIG. 1, a network implementation 100 of a system 102 for inventory management based on augmented reality within a warehouse is disclosed. Although the present subject matter is explained considering that the system 102 is implemented on a server 110, it may be understood that the system 102 may also he implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that multiple users may access the system 102 through one or more user device 104-1, 104-2 . . . 104-N, collectively referred to as user device 104 hereinafter, or applications residing on the user device 104. Examples of the user device 104 may include, but are not limited to, a portable computer, a personal digital assistant, a handheld system, and a workstation. The user device 104 may be communicatively coupled to the system 102 through a network 106. Further, the system 102 may be communicatively coupled with the wearable device 108-1 . . . 108-N, herein after referred to as wearable device 108. In one example, the wearable device may be a smart glass, smart watch and the like. The wearable device 108 may be enabled with a camera 112. In one example, the camera maybe focused away from the user eyes in the direction of the user gaze. Further, the camera of the wearable device may he configured to capture a video stream.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may be either a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network systems, including routers, bridges, servers, computing systems, storage systems and the like.

In one embodiment, the system 102 may receive a video stream from the wearable device 108 associated with a user in a warehouse and identify a product and one or more parameters associated with the product based on analysis of the video stream. In one example, the video stream may correspond to gaze direction associated with the user and comprises one or more video frames corresponding to the product. Upon identifying, the system 102 may generate validation data based on validation of the product with a validation list. In an example, the validation data may comprise a date, a time and a result of the validation, and the validation list may comprise inventory data associated with a set of products to may be validated. Subsequent to validation, the system 102 may update the inventory data with the validation data associated the product, thereby enabling inventory management using augmented reality within a warehouse.

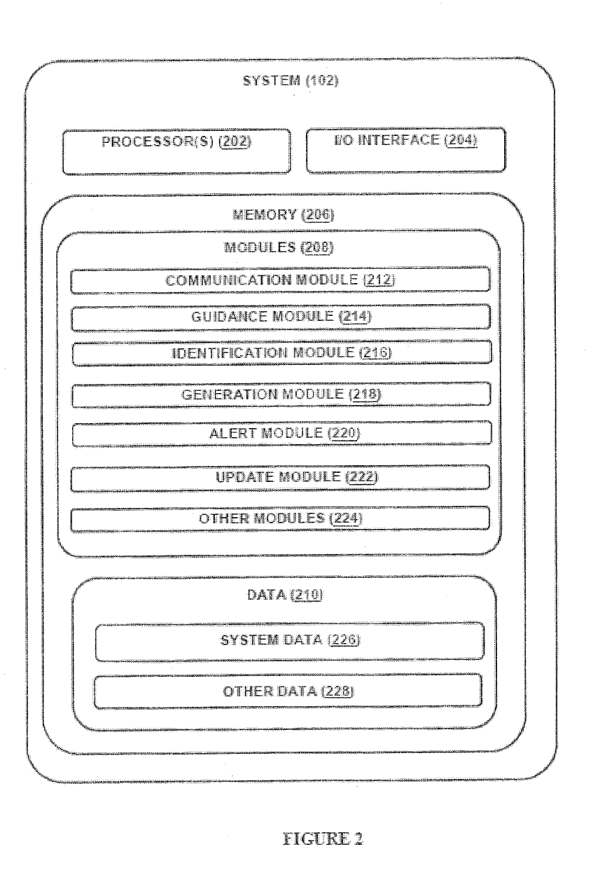

Referring now to FIG. 2, the system 102 for inventory management based on augmented reality within a warehouse is illustrated in accordance with an embodiment of the present subject matter. In one embodiment, the system 102 may be configured to communicate with a wearable device 108. The system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any systems that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing systems, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of systems to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a communication module 212, a guidance module 214, an identification module 216, a generation module 218, an alert module 220, an update module 222 and other modules 224. The other modules 224 may include programs or coded instructions that supplement applications and functions of the system 102.

The data 210, amongst other things, serve as a repository for storing data processed, received, and generated by one or more of the modules 208. The data 210 may also include a system data 226, and other data 228. In one embodiment, the other data 228 may include data generated as a result of the execution of one or more modules in the other module 224.

In one implementation, a user may access the system 102 via the 110 interface 204. The user may be registered using the I/O interface 204 in order to use the system 102. In one aspect, the user may access the I/O interface 204 of the system 102 for obtaining information, providing inputs or configuring the system 102.

In one embodiment of the system 102 for inventory management based on augmented reality within a warehouse, the communication module 212, may receive a user location data from the wearable device associated with the user, and a product location data of one or more products within the warehouse, from an inventory database. In one example, the user location may be computed, by a location module in the wearable device or the system, 102, based on one of GPS data of the wearable device and comparison of image data of area surrounding the user captured using the camera of the wearable device with a stored data. Upon receiving, the communication module 212 may store the user location data and the product location data in system data 226.

Further, in the embodiment, upon receiving the user location data and the product location data, the generation module 218 may generate a validation list based on comparison of the user location data and the product location data. In one example, the validation list may comprise inventory data associated with a set of products to be validated in the vicinity of the user. Further, the generation module 218 may store the validation list in the system data 226

Subsequent to generation of the validation list, the guidance module 214 generate a set of instruction for guiding the user to a product location associated with a product from the set of products based on the user location data and the product location data. Further, the guidance module 214 may transmit the validation list and the instructions for display on the wearable device 108. Furthermore, the guidance module 214 may store the instructions in system data 226.

In one embodiment, the user may follow the instructions provided by the guidance module 214 to reach the location of the product to be validate. In the said embodiment, the communication module 212, may receive a video stream from the wearable device. In one example, the video stream may correspond to gaze direction of the user. Further, the communication module 212 may store the video stream in system data 226.

Further to receiving the video stream, the identification module 216, may identifying a product and one or more parameters associated with the product based on analysis of the video stream. In one example, the identification module 216 identify based on image recognition technique. In one other example, the one or more parameters may comprise a size, a colour, a quantity, and the like of the product. In one more example, the video stream comprises one or more video frames corresponding to the product. Further, the identification module 216 may store the identification data in system data 226.

Subsequent to identification of the product, the generation module 218 may generate validation data based on validation of the product with the validation list. In one example, the validation data may comprise a date, a time and a result of the validation such as validate or not validate, and the validation list comprises the inventory data. Further, the generation module 218 may store the validation data in system data 226.

Upon generating the validation data, the alert module 220, may generate an exception alert if the validation of the product fails. In one example, the failure of validation may result if there is a mismatch between the inventory data in the validation list and the inventory identified by the identification module 216. Further, the alert module 220 may display the alert to the user over the wearable device 108 and to the user's manager for approval. The alert module may also instruct the user to execute the validation process again as describe above i.e gaze at the product to capture video stream. In one embodiment, the user may provide indication to initiate the video capturing of the gaze direction, such by blinking twice.

Subsequently, the update module 222 may update the inventory data with the validation data, thereby enabling inventory management using augmented reality within a warehouse.

Exemplary embodiments for inventory management using augmented reality within a warehouse discussed above may provide certain advantages. Though not required to practice aspects of the disclosure, these advantages may include those provided by the following features.

Some embodiments of the system and the method enable effective inventory control, inventory turnover and inventory management.

Some embodiments of the system and the method reduce the operation cost of inventory management.

Some embodiments of the system and the method increase resource productivity.

Some embodiments of the device and the method enable automated inventory management.

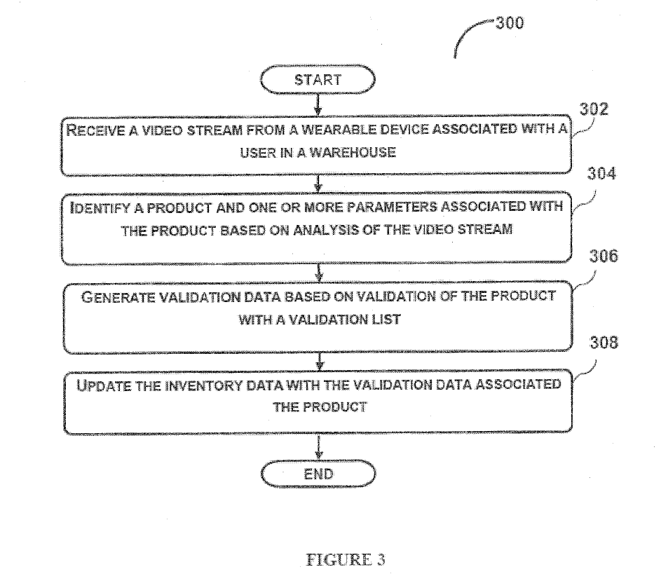

Referring now to FIG. 3, a method 300 for inventory management using augmented reality within a warehouse, is disclosed in accordance with an embodiment of the present subject matter. The method 300 for inventory management using augmented reality within a warehouse may be described in the general context of computer executable instructions. Generally, computer executable instructions can include routines, programs, objects, components, data structures, procedures, modules, functions, and the like, that perform particular functions or implement particular abstract data types. The method 300 for inventory management using augmented reality within a warehouse may also be practiced in a distributed computing environment where functions are performed by remote processing systems that are linked through a communications network. In a distributed computing environment, computer executable instructions may be located in both local and remote computer storage media, including memory storage systems.

The order in which the method 300 for inventory management using augmented reality within a warehouse is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 for inventory management using augmented reality within a warehouse may be considered to be implemented in the above-described system 102.

At block 302, a video stream from a wearable device associated with a user in a warehouse may be received. In one example, the video stream corresponds to gaze direction associated with the user. In one embodiment, the communication module 212 may receive a video stream from a wearable device associated with a user in a warehouse. Further, the communication module 212 may store the video stream in system data 226.

At block 304, a product and one or more parameters associated with the product may be identified based on analysis of the video stream. In one example, the video stream may comprise one or more video frames corresponding to the product. In one embodiment, the identification module 216 may identify a product and one or more parameters associated with the product based on analysis of the video stream. Further, the identification module 216 may store the identification data in system data 226.

At block 306, validation data may be generated based on validation of the product with a validation list. In one example, the validation data may comprise a date, a time and a result of the validation, and the validation list may comprise inventory data associated with a set of products to be validated. In one embodiment, the generation module 218 may generate validation data based on validation of the product with a validation list. Further, the generation module 218 may store the validation data in system data 226.

At block 308, the inventory data may be updated with the validation data associated the product, thereby enabling inventory management using augmented reality within a warehouse. In one embodiment, the update module 222 may update the inventory data with the validation data associated the product, thereby enabling inventory management using augmented reality within a warehouse. Further, the update module 222 may store the updated inventory data in system data 226.

Although implementations for methods and systems for inventory management using augmented reality within a warehouse have been described in language specific to structural features and/or methods, it is to be understood that the appended claims are not necessarily limited to the specific features or methods for inventory management using augmented reality within a warehouse described. Rather, the specific features and methods are disclosed as examples of implementations for inventory management using augmented reality within a warehouse.

We claim:

1. A method for inventory management using augmented reality within a warehouse, the method comprises steps of:
receiving, by a processor, a video stream from a wearable device associated with a user in a warehouse, wherein the video stream corresponds to gaze direction of the user;
identifying, by the processor, a product and one or more parameters associated with the product based on analysis of the video stream, wherein the video stream comprises one or more video frames corresponding to the product;
generating, by the processor, validation data based on validation of the product with a validation list, wherein the validation data comprises a date, a time and a result of the validation, and wherein the validation list comprises inventory data associated with a set of products to be validated; and
updating, by the processor, the inventory data with the validation data associated the product, thereby enabling inventory management using augmented reality within a warehouse.

2. The method of claim 1 further comprising:
receiving by a processor, a user location data from the wearable device associated with the user, and a product location data of one or more products within the warehouse, from an inventory database;
generating, by a processor, the validation list based on comparison of the user location data and the product location data, wherein the validation list comprises the inventory data associated with a set of products to be validated in a vicinity of the user; and
guiding, by the processor, the user to a product location associated with a product from the set of products based on the user location data and the product location data.

3. The method of claim 1 further comprises, generating, by the processor, an exception alert based on the validation data.

4. The method of claim 1, wherein the video stream is captured by a camera of the wearable device focused away from eyes of the user, and wherein the user location data is captured by a location module of the wearable device.

5. A system for inventory management using augmented reality within a warehouse, the system comprising:
a memory; and
a processor coupled to the memory, wherein the processor is configured to:
receiving a video stream from a wearable device associated with a user in a warehouse, wherein the video stream corresponds to gaze direction of the user;
identifying a product and one or more parameters associated with the product based on analysis of the video stream, wherein the video stream comprises one or more video frames corresponding to the product;
generating validation data based on validation of the product with a validation list, wherein the validation data comprises a date, a time and a result of the validation, and wherein the validation list comprises inventory data associated with a set of products to be validated; and
updating the inventory data with the validation data associated the product, thereby enabling inventory management using augmented reality within a warehouse.

6. The system of claim 5 further comprising:
receiving a user location data from the wearable device associated with the user, and a product location data of one or more products within the warehouse, from an inventory database;
generating the validation list based on comparison of the user location data and the product location data, wherein the validation list comprises the inventory data associated with a set of products to be validated in a vicinity of the user; and
guiding the user to a product location associated with a product from the set of products based on the user location data and the product location data.

7. The system of claim 5 further comprises generating an exception alert based on the validation.

8. The system of claim 5, wherein the video stream is captured by a camera of the wearable device focused away from eyes of the user, and wherein the user location data is captured by a location module of the wearable device.

9. A non-transitory computer program product having embodied thereon a computer program for inventory management using augmented reality within a warehouse, the computer program product storing instructions for:
receiving a video stream from a wearable device associated with a user in a warehouse, wherein the video stream corresponds to gaze direction of the user;
identifying a product and one or more parameters associated with the product based on analysis of the video stream, wherein the video stream comprises one or more video frames corresponding to the product;
generating validation data based on validation of the product with a validation list, wherein the validation data comprises a date, a time and a result of the validation, and wherein the validation list comprises inventory data associated with a set of products to be validated; and
updating the inventory data with the validation data associated the product, thereby enabling inventory management using augmented reality within a warehouse.

10. The non-transitory computer program product of claim 9 further comprising:
receiving a user location data from the wearable device associated with the user, and a product location data of one or more products within the warehouse;
generating the validation list based on comparison of the user location data and the product location data, wherein the validation list comprises the set of products and one or more parameters associated with the set of product to be validated in a vicinity of the user; and
guiding the user to a product location associated with a product from the set of products based on the user location data and the product location data.
